(19) United States
(12) Patent Application Publication
(10) Pub. No.: US 2001/0054314 A1
(43) Pub. Date: Dec. 27, 2001

(54) Pressure sensor and pressure sensor circuit

(76) Inventor: Yoshihiro Hirao, Tokyo (JP)

Correspondence Address: McGuire Woods, Suite 1800, 1750 Tysons Boulevard, McLean, VA, 22102-3915, US

(21) Appl. No.: 09/874,063

(22) Filed: Jun. 6, 2001

(30) Foreign Application Priority Data
Jun. 7, 2000 (JP) P.2000-169945
Jul. 6, 2000 (JP) P.2000-205262
Jul. 27, 2000 (JP) P.2000-226478
Sep. 5, 2000 (JP) P.2000-268808

(51) Int. Cl. G01L 7/08

(52) U.S. Cl. 73/715

(57) ABSTRACT

In a pressure sensor, a first contact electrode is formed on a base board. A second contact electrode is formed on the base board such that a top face thereof is made flush with a top face of the first contact electrode. A deformable click rubber has a flat bottom face opposed to the first and second contact electrodes. The flat bottom face is in parallel with the top faces of the first and second contact electrodes. The sensor generates an output signal when the click rubber is brought into contact with the first contact electrode. A contact area between a bottom portion of the click rubber and the second contact electrode varies in accordance with the deformation of the click rubber to vary an amplitude of the output signal.

### BACKGROUND OF THE INVENTION

The present invention relates to a pressure sensor which is used in, for example, a keyboard or a controller for a game machine, and more particularly to a pressure sensor in which an “ON” signal is generated in response to a contact between a rubber and a contact, and the electrostatic capacitance is changed by an approaching and press-contacting operations between the rubber and the contact. The present invention further relates to a circuit used for the pressure sensor.

Related pressure sensors of this kind will be described with reference to FIGS. 9 to 12. FIG. 9 shows a first case where a pressure sensor is used in a controller switch 1 for a game. In the game controller switch 1, a pair of first contacts 3 and 4 are disposed on a circuit board 2, a second contact 5 having a C-like shape in a plan view is placed with being separated from the pair of the first contacts 3 and 4, and a rubber 6 made of silicon or the like is disposed with being opposed to the first contacts 3 and 4 and the second contact 5. The first contacts 3 and 4, the second contact 5, and the rubber 6 constitute a pressure sensor 7.

The top faces of the first contacts 3 and 4 and the second contact 5 which are opposed to the rubber 6 are made flush. A peripheral bottom face 6a of the rubber 6 which is opposed to the second contact 5 is formed in parallel to the top face of the second contact 5. A center portion of the bottom face of the rubber 6 which is opposed to the first contacts 3 and 4 protrudes from the peripheral face 6a toward the first contacts 3 and 4 to form a protrusion 6b.

The rubber 6 is fixed to a lower end portion of the click rubber body 10 of a click rubber 9 having a flexible leg 8. The flexible leg 8 is placed on the circuit board 2. A button 11 is secured to the upper end of the click rubber body 10. The first contacts 3 and 4, the second contact 5, the rubber 6, and the click rubber 9 are housed in a case 12. In the button 11, a lower portion 11a is housed in the case 12, and an upper portion 11b is passed through an upper portion of the case 12 to upward protrude therefrom.

When the button 11 is pressed, the flexible leg 8 of the click rubber 9 is deformed and the click rubber body 10 is downward moved, so that the protrusion 6b of the rubber 6 disposed on the click rubber body 10 contacts the first contacts 3 and 4 to establish conduction between the first contacts 3 and 4, whereby an “ON” signal can be obtained. When the button 11 is further depressed, the protrusion 6b is compressively deformed, so that the peripheral face 6a approaches and contacts the second contact 5 and then pressingly contacts it.

According to this configuration, a change of the electrostatic capacitance between the peripheral face 6a of the rubber 6 and the second contact 5 occurs, and an electric signal corresponding to the operation of pressing the button 11 can be obtained by performing so-called C/V conversion (not shown) which converts the electrostatic capacitance to an output voltage.

FIG. 10 is a graph showing an output with respect to a press load on the game controller switch 1. During a process A in which the load is increased from 0 to a give load F1 by depressing the switch, a constant output V1 is generated, and the “ON” signal is obtained by the constant output V1. When the load is increased to be larger than F1, the output is increased in proportion to the increase of the load, and the linearity of the load-output characteristics at this time is excellent.

By contrast, during a process B, in which the switch is returned, the output is reduced substantially in proportion to the reduction of the load. However, there is a problem in that, as shown in the figure, the linearity is inferior than that during the process A in which the switch is pressed, and the hysteresis characteristics are instable.

FIG. 11 shows a second related controller switch 13 for a game. In the game controller switch 13, a pressure sensor 14 is disposed in place of the pressure sensor 7 of the game controller switch 1. In the pressure sensor 14, first contacts 15 and 16 which are taller than the first contacts 3 and 4 of the pressure sensor 7 are disposed, and a rubber 17 in which bottom faces opposed to the first contacts 15, 16 and the second contact 5 are made flush.

When the button 11 is pressed, the rubber 17 first contacts the first contacts 15 and 16, whereby an “ON” signal can be obtained. Furthermore, the contacting portion of the rubber 17 is compressively deformed, and the peripheral portion of the rubber 17 then approaches and contacts the second contact 5 and then pressingly contacts it, whereby a change of the electrostatic capacitance between the peripheral portion and the second contact 5 is caused. When the electrostatic capacitance is C/V-converted, it is possible to obtain an electric signal corresponding to the operation of pressing the button 11.

In the same manner as the game controller switch 1, the game controller switch 13 exerts excellent linearity of the load-output characteristics during a process of depressing the switch, but has the problem in that the hysteresis characteristics are instable during the process in which the switch is returned.

FIG. 12 shows a third related controller switch 18 for a game. In the game controller switch 18, a pressure sensor 19 is disposed in place of the pressure sensor 14 of the game controller switch 13. In the pressure sensor 19, a pair of first contacts 20 and 21 are disposed on the circuit board 2 with being separated from each other, and a second contact 22 having a U-like shape in a plan view is placed in a middle portion between the pair of first contacts 20 and 21. The paired first contacts 20 and 21 are formed so as to be taller than the second contact 22. The rubber 17 which is identical with that of the pressure sensor 14 is disposed so as to be opposed to the first contacts 20 and 21 and the second contact 22.

When the button 11 is pressed, the peripheral portion of the rubber 17 contacts the first contacts 20 and 21, whereby an “ON” signal can be obtained. Furthermore, the contacting portion of the rubber 17 is compressively deformed. In accordance with the deformation, the center portion of the rubber 17 then approaches and contacts the second contact 22 and then pressingly contacts it, whereby a change of the electrostatic capacitance between the second contact 22 and the rubber 17 is caused. When the electrostatic capacitance is C/V-converted, it is possible to obtain an electric signal corresponding to the operation of pressing the button 11.

In the same manner as the game controller switch 1, the game controller switch 18 exerts excellent linearity of the load-output characteristics during a process of depressing the switch, but has the problem in that the hysteresis characteristics are instable during the process of depressing the switch.

In the first related pressure sensor, the protrusion is disposed on the rubber, the “ON” signal is obtained in response to a contact between the protrusion and the first contacts, the electrostatic capacitance is changed by an approaching and press-contacting operations between the peripheral portion outside the protrusion and the second contact, and an electric signal corresponding to the operation of pressing the button can be obtained by performing C/V conversion on the electrostatic capacitance.

In the second and third related pressure sensors, the bottom face of the rubber which is opposed to the first and second contacts is made flat, and the first contacts are changed in height from the second contact, so that the “ON” signal is obtained in response to a contact between the rubber and the first contacts, and an electric signal corresponding to the operation of pressing the button can be obtained by approaching, and press-contacting operations between the rubber and the second contact.

In the production of the pressure sensors, however, a complicated work of providing the protrusion on the rubber, or changing the height of the first contacts from that of the second contact must be conducted. Further, the related pressure sensors exert excellent linearity of the output, but have a problem in that the reproducibility of the output characteristics, and the hysteresis characteristics are instable.

Such a pressure sensor is configured as shown in FIG. 13. In this figure, the pressure sensor 201 is configured by laminatedly disposing an electrode layer 203 and a sensor layer 204 on a printed circuit board 202 which is placed in, for example, a keyboard, and then a protection cover 205 is superposed thereon.

For example, the electrode layer 203 is configured by forming an electrode with a conductive pattern of silver paste or the like, on a film sheet. In the illustrated example, the electrode portion has a pair of comb-like electrodes 203a and 203b.

The sensor layer 204 is configured by applying carbon resistor or the like onto a sheet made of, for example, polyethylene to form an electrode 204a. The electrode 204a is formed so as to be opposed to the whole electrodes 203a and 203b of the electrode layer 203.

The pressure sensor 201 having this configuration is assembled in the following manner. First, the electrode layer 203 is pasted to a predetermined position of the surface of the printed circuit board 202. Then, the sensor layer 204 and the protection cover 205 are sequentially pasted to the surface of the electrode layer 203. Furthermore, connecting lands of the electrodes 203a and 203b of the electrode layer 203 are electrically connected to those on the printed circuit board 202 by reflow soldering or the like, thereby mounting the sensor onto the printed circuit board 202.

In the pressure sensor 201 having this configuration, however, the electrodes 203a and 203b of the electrode layer 203 are configured by a conductive pattern made of a metal, and hence the cost is raised.

In the assembling process, the electrode layer 203 and the sensor layer 204 must be sequentially pasted to a predetermined position of the surface of the printed circuit board 202, and the electrodes 203a and 203b of the electrode layer 203 must be electrically connected to the connecting lands of the printed circuit board 202. Therefore, the assembling work is complicated, and the assembly cost is raised.

A related circuit used in this kind of pressure sensor will be described with reference to FIGS. 14 and 15. In FIG. 14, a pressure sensor circuit 301 is schematically shown. For example, the pressure sensor circuit 301 is used in a contact portion of a switch or the like, and comprises a plurality of XOR-AMP circuits (exclusive OR gate-amplifier circuits) 302 which are adequately connected in the required number corresponding to the number of pressure sensors (not shown) that are used as contacts.

As indicated by the single-dashed line in FIG. 15, for example, each of the XOR-AMP circuits 302 constitutes a so-called C/V converting circuit which converts an electrostatic capacitance to a voltage, and an amplifying circuit. In the XOR-AMP circuit, a resistor 303 for delaying a signal, an XOR (exclusive OR) gate 304 which performs an exclusive OR operation, and an AMP (amplifier) 305 serving as a differential amplifier which amplifies the difference between two signals are connected in series.

As shown in the figure, the resistor 303 of the XOR-AMP circuit 302 is connected to an input terminal 306 to which a rectangular wave signal of a predetermined frequency is supplied from an AC signal source. The input terminal 306 is connected also to the other terminal of the XOR gate 304.

A pressure sensor 307 which detects an operation on the switch or the like by a change of an electrostatic capacitance, and which has a so-called capacitor function of changing the degree of delay of a signal in accordance with a change of the electrostatic capacitance is connected between the resistor 303 of the XOR-AMP circuit 302 and the XOR gate 304. The other terminal of the pressure sensor 307 is grounded. In the figure, the reference numeral 308 denotes a power source, the reference numerals 309 to 312 denote resistors, and the reference numeral 313 denotes a capacitor.

According to this configuration, the rectangular wave signal which has been received through the input terminal 306 is branched into two signals. One signal is delayed by the resistor 303 and the pressure sensor 307, and then input into the XOR gate 304. The other signal is input into the XOR gate 304 as a signal which is not passed through the resistor 303 nor delayed. The XOR gate 304 outputs only the delayed portion. The delayed portion is amplified by the amplifier 305. The amplified output is appropriately used as a control signal or the like.

In this case, a general-purpose XOR-AMP circuit is used as the XOR-AMP circuit 302, and the pressure sensor circuit 301 is configured by using a plurality of such general-purpose XOR-AMP circuits.

However, such general-purpose XOR-AMP circuits are independently produced, and hence their characteristics are varied, thereby producing a disadvantage that the pressure sensor circuit 301 using a plurality of such general-purpose XOR-AMP circuits cannot attain a stabilized characteristic.

### SUMMARY OF THE INVENITON

It is therefore a first object of the invention is to realize a pressure sensor of a simple configuration, and stabilize the reproducibility of the output characteristics, and the hysteresis characteristics.

A second object of the invention to provide a pressure sensor which has a simple configuration that can be easily assembled, and in which the assembly cost and the part cost can be reduced.

A third object of the present invention is to reduce dispersion of characteristics of a plurality of XOR-AMP circuits in a pressure sensor circuit and stabilize the characteristic of the pressure sensor circuit.

In order to achieve the first object, according to the invention, there is provided a pressure sensor, comprising:

a base board;

a first contact electrode formed on the base board;

a second contact electrode formed on the base board such that a top face thereof is made flush with a top face of the first contact electrode; and

a deformable click rubber having a flat bottom face opposed to the first and second contact electrodes, the flat bottom face being parallel with the top faces of the first and second contact electrodes,

wherein the sensor generates an output signal when the bottom face of the click rubber is brought into contact with the first contact electrode; and

wherein a contact area between a bottom portion of the click rubber and the second contact electrode varies in accordance with the deformation of the click rubber to vary an amplitude of the output signal.

In this configuration, it is not necessary to provide a protrusion on the click rubber, and the first and second contacts are not required to be changed in height, so that the output signal can be obtained by a simple configuration using parts of a usual shape, and the output signal corresponding to the operation of pressing the click rubber can be also obtained. The linearity also is not problematic for practical usage. Since the click rubber pressingly contacts the second contact in a wider area, the reproducibility of the output characteristics, and the hysteresis characteristics are stabilized as compared with the related examples.

As a result, the invention attains noticeable effects such as that a pressure sensor can have a simple configuration to reduce the cost, and that the reproducibility of the output characteristics of the pressure sensor, and the hysteresis characteristics can be stabilized.

According to the invention, there is also provided a pressure sensor, comprising:

a base board;

a contact electrode formed on the base board; and

a deformable click rubber including a columnar body whose bottom face is opposed to the contact electrode,

wherein the sensor generates an output signal when the bottom face of the click rubber is brought into contact with the contact electrode;

wherein a contact area between a bottom portion of the click rubber and the contact electrode varies in accordance with the deformation of the click rubber to vary an amplitude of the output signal; and

wherein a hollowed portion is formed in an upper central portion of the columnar body such that a peripheral portion of the click rubber surrounding the hollowed portion is easier to deform than the bottom portion of the click rubber.

In this configuration, after the bottom face of the columnar body is brought into contact with the contact electrode, pressing operation causes the click rubber body to contact an electrode, the peripheral portion of the click rubber surrounding the hollowed portion is further deformed, so that the output of the pressure sensor is increased substantially linearly with respect to an increase of the press load. Namely, the linearity is enhanced and the operability by the operator is remarkably improved.

As a result, the invention attains noticeable effects such as that, in a pressure sensor, the linearity of the output characteristics with respect to a press load can be enhanced to improve the operability.

In order to achieve the second object, according to the invention, there is provided a pressure sensor comprising:

an electrode layer including a contact electrode, the electrode layer integrally formed with a base board as a single layer; and

a sensor layer laminated on the electrode layer.

Preferably, an electrode in the electrode layer is carbon-printed on the base board.

According to the invention, there is also provided a method of manufacturing a pressure sensor, comprising the steps of:

carbon-printing a contact electrode directly on a base board to form a single electrode layer; and

laminating a sensor layer on the electrode layer.

In the above configurations, the pressure sensor can be assembled by simply laminating the sensor layer onto the electrode layer integrally provided with the base board. Since the electrode layer is not required to be laminated onto a predetermined position of the base board, when the contact electrode is formed integrally with a conductive pattern, which constitutes another circuit and is formed on the base board, so that it is not necessary to electrically connect the contact electrode with connecting lands on the base board. Accordingly, the part cost and the assembly cost can be reduced, and the assembling work can be easily performed.

When the contact electrode is formed by carbon-printing, the cost can be further reduced because a conductive pattern made of a metal is not used.

As a result, according to the invention, it is possible to provide a very excellent pressure sensor which has a simple configuration that can be easily assembled, and in which the assembly cost and the part cost can be reduced.

In order to achieve the third object, according to the invention, there is provided a pressure sensor circuit, comprising:

a plurality of circuits, each including an exclusive-OR gate element and an amplifier element which are connected in serial; and

a single wafer, on which the plural circuits are mounted.

According to the invention, there is also provided a package integrated circuit, comprising:

a plurality of pressure sensor circuits, each including an exclusive-OR gate element and an amplifier element which are connected in serial; and

a single wafer, on which the plural pressure sensor circuits are mounted.

In the above configurations, since the XOR-AMP circuits can be fabricated by the same process, so that characteristics of the XOR-AMP circuits are less dispersed. Consequently, the characteristic of the pressure sensor circuit configured by the XOR-AMP circuits is stabilized, and the XOR-AMP circuits can be produced more economically than the related general-purpose XOR-AMP circuits.

As a result, the invention attains noticeable effects such as that dispersion of characteristics of a plurality of XOR-AMP circuits in a pressure sensor circuit can be reduced, the characteristic of the pressure sensor circuit can be stabilized, and the production cost can be lowered.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a section view of a switch using a pressure sensor according to a first embodiment of the invention;

FIG. 2 is a plan view showing the arrangement of first and second contacts of FIG. 1;

FIG. 3 is a partial enlarged view showing a state in which a rubber of FIG. 1 is brought into a press-contact with the first and second contacts;

FIG. 4 is a graph showing relationships between a load and an output in the switch of FIG. 1;

FIG. 5 is a partial section view of a switch using a pressure sensor according to a second embodiment of the invention;

FIG. 6 is a graph showing relationships between a load and an output in the switch of FIG. 5;

FIG. 7 is a schematic perspective view showing an exploded pressure sensor of the invention;

FIG. 8 is a schematic view of a pressure sensor circuit according to one embodiment of the invention;

FIG. 9 is a section view of a switch using a first related pressure sensor;

FIG. 10 is a graph showing relationships between a load and an output in the switch of FIG. 9;

FIG. 11 is a section view of a switch using a second related pressure sensor;

FIG. 12 is a section view of a switch using a third related pressure sensor;

FIG. 13 is a schematic perspective view showing an exploded related pressure sensor;

FIG. 14 is a schematic view of a related pressure sensor circuit; and

FIG. 15 is a circuit diagram of an XOR-AMP circuit of FIG. 14.

### DETAILED DESCIRIPTION OF THE PREFERRED EMBODIMENTS

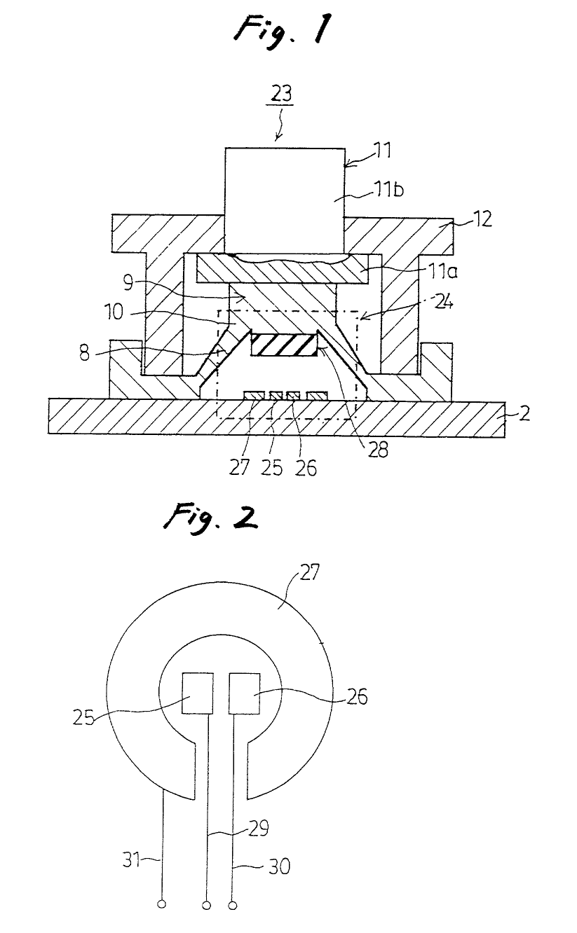

Hereinafter, a first embodiment of the invention will be described in detail with reference to FIGS. 1 to 4. For the sake of convenience in description, components identical with those of the related examples are denoted by the same reference numerals, and their description is omitted. FIG. 1 shows a case where the pressure sensor of the invention is used in a controller switch 23 for a game. In the game controller switch 23, a pressure sensor 24 is disposed. However, the pressure sensor of the invention is not restricted to be used in such a controller switch for a game.

The pressure sensor 24 is configured by: a pair of first contacts 25 and 26 which are disposed on a circuit board 2; a second contact 27 having a C-like shape in a plan view; and a rubber 28 which is made of silicon or the like, and which is opposed to the first contacts 25 and 26 and the second contact 27. Top faces of the first contacts 25 and 26 and the second contact 27 which are opposed to the rubber 28 are made flush. A bottom face of the rubber 28 which is opposed to the first contacts 25 and 26 and the second contact 27 is made flat. The opposed faces are configured so as to be parallel to each other. In the figure, the rubber 28 is fixed to a lower portion of the click rubber body 10. Alternatively, the rubber may be formed integrally with the click rubber 9.

FIG. 2 shows the arrangement of the first contacts 25 and 26 and the second contact 27. The pair of the first contacts 25 and 26 are disposed in a center portion, and the second contact 27 having a C-like shape is placed with being outward separated from the first contacts 25 and 26. Lead wires 29 and 30 are connected to the pair of the first contacts 25 and 26, respectively, and a lead wire 31 is connected to the second contact 27.

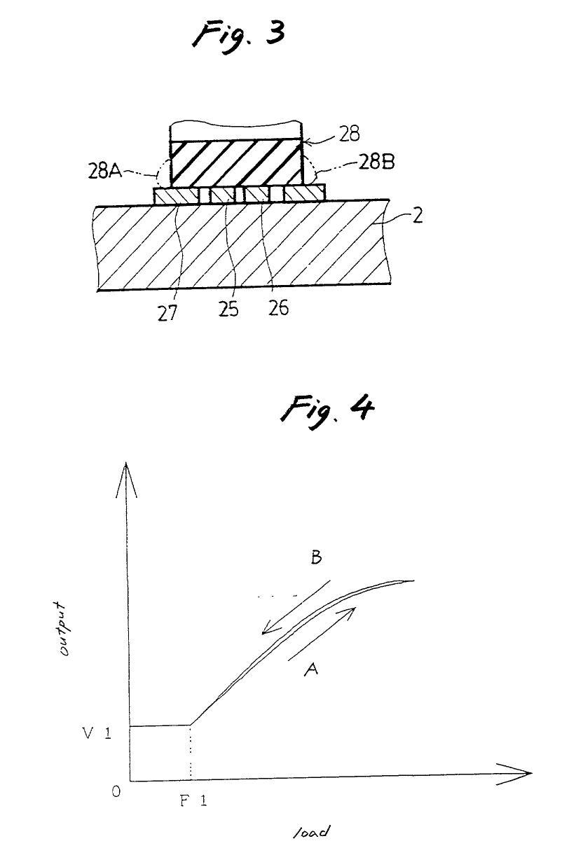

When the button 11 is pressed, the flexible leg 8 of the click rubber 9 is deformed and the click rubber body 10 is downward moved, so that the rubber 28 disposed on the click rubber body 10 contacts the first contacts 25 and 26 and the second contact 27. When conduction between the first contacts 25 and 26 is established through the rubber 28, an “ON” signal can be obtained. When the rubber 28 is further pressed toward the second contact 27 to be deformed as indicated by phantom lines 28A and 28B in FIG. 3, the contact area or the approaching area between the rubber 28 and the second contact 27 is increased, thereby changing the electrostatic capacitance. An electric signal corresponding to the operation of pressing the button 11 can be obtained by performing C/V conversion (not shown) on the electrostatic capacitance.

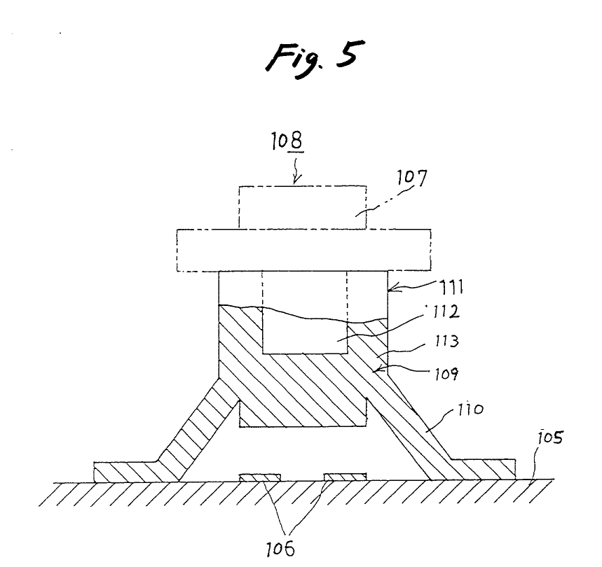

FIG. 4 is a graph showing an output with respect to a press load on the game controller switch 23. During a process A in which the load is increased from 0 to a given load F1 by depressing the switch, a constant output V1 is generated, and the “ON” signal is obtained by the constant output V1. When the load is increased to be larger than F1, the output is increased substantially in proportion to the increase of the load. The linearity of the load-output characteristics during the process of increasing the output is slightly inferior than those of the related game controller switch 1, but does not produce a significant problem in a practical use.

By contrast, during a process B in which the switch is returned, the output is reduced substantially in proportion to the reduction of the load. As shown in the figure, the output is reduced in along a locus which is approximately identical with that during the process of pressing the switch. Therefore, the hysteresis characteristics are stable.

According to the invention, therefore, it is not necessary to dispose a protrusion on the rubber 28, and the first contacts 25 and 26 and the second contact 27 are not required to be changed in height, so that an “ON” signal can be obtained by a simple configuration using parts of a usual shape, and an electric signal corresponding to the operation of pressing the button 11 can be obtained. The linearity also is not problematic for practical usage.

In the invention, as compared with the related examples, the rubber 28 pressingly contacts the second contact 27 in a wider area, and hence the reproducibility of the output characteristics, and the hysteresis characteristics are stabilized.

However, the operator of the pressure sensor tends to feel that the operability is more excellent when the pressing force is approximately proportional to the output, or as the so-called linearity is higher. When the rate of increase of the output is reduced as the load is increased, or the linearity is low as shown in FIG. 4, the operator feels a sense of incompatibility and thinks that the operability is poor.

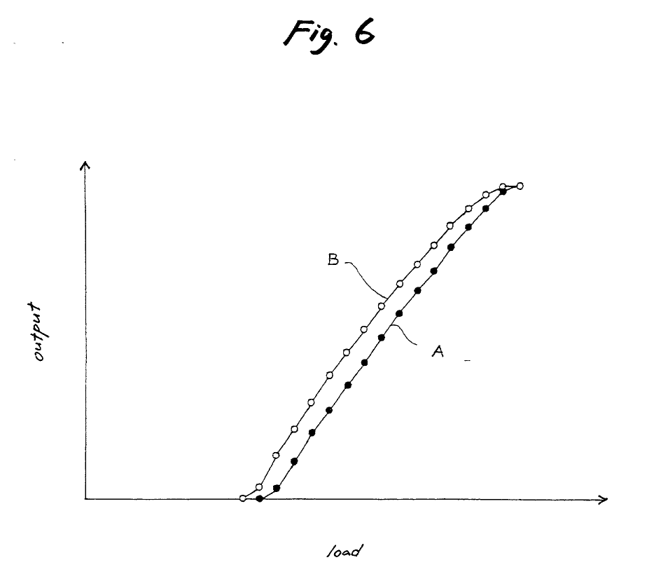

With reference to FIGS. 5 and 6, there will be described a pressure sensor according to a second embodiment in which the linearity of the output with respect to the press load when the button is depressed is enhanced so as to improve the operability.

In a pressure sensor 108, a click rubber 111 disposed on a circuit board 105 includes a columnar body 109 capable of being compressively deformed when pressing force is applied. Flexible legs 110 are elongated from the outer peripheral portion of the lower end of the body 109 in an oblique downward direction. A hollow portion 112 is formed in an upper center portion of the body 109 so as to open upwards. Therefore, an upper outer peripheral portion 113 of the body 109 is formed into a cylindrical shape which is easily deformed by the pressing force.

Electrodes 106 (here, simplified) are disposed on the circuit board 105 in a position below the body 109. When a button 107 is pressed, the body 109 is pressed and the flexible leg 110 is bent, so that the upper outer peripheral portion 113 of the body 109 defined by the hollow portion 112 is deformed, thereby causing the body 109 to approach and then contact with the electrode 6. As a result, the pressure sensor 108 generates an output.

When the pressing operation on the button 107 is further depressed, the upper outer peripheral portion 113 is further deformed, and the body 109 is compressively deformed, so that the output of the pressure sensor 108 is raised in accordance with the compressive deformation of the upper outer peripheral portion 1 13 and the body 109.

Namely, after the body 109 is brought into contact with the electrodes 106, the upper outer peripheral portion 113 is further deformed, so that the displacement amount of the pressure sensor becomes large. As a result, as shown in FIG. 6, the pressure sensor 108 exhibits so-called linear characteristics wherein, in the process A in which the press load is increased, the output is increased as the load is made larger, and the rate of increase of the output is substantially constant even when the load is made larger. In the process B in which the press load is reduced, the output is reduced along a straight line which is similar to that of the forward path.

In this way, the output is increased substantially linearly with respect to an increase of the press load. Therefore, the linearity is enhanced so that the operability by the operator is remarkably improved.

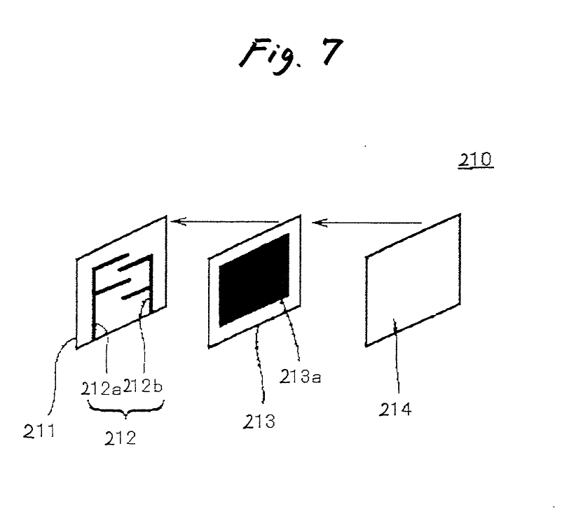

Next, the configuration to achieve the second object of the invention will be described with reference to FIG. 7 which is a schematic perspective view showing an exploded pressure sensor.

A pressure sensor 210 is formed integrally with a circuit board 211 constituting, for example, a controller for a game machine, and includes: an electrode layer 212 configured by electrodes 212a and 212b which are formed on the surface of the circuit board 211; a sensor layer 213 which is disposed on the electrode layer 212; and a protection cover 214 which is placed on the sensor layer 213.

The electrode layer 212 is configured such that the electrodes are formed directly in predetermined positions of the surface of the printed circuit board 211 by means of carbon printing. In the embodiment, the electrode layer 212 includes the pair of electrodes 212a and 212b.

For example, the sensor layer 213 is configured such that carbon resistor is applied onto a sheet of polyethylene to form an electrode 213a. The electrode 213a is formed so as to be opposed to the whole electrodes 212a and 212b of the electrode layer 212.

The sensor layer 213 is attached to the surface of the electrode layer 212 by an adhesive agent or the like.

The protection cover 214 is attached to the surface of the sensor layer 213 by an adhesive agent or the like.

In this embodiment, the pressure sensor 210 as described above is assembled in the following manner. First, the sensor layer 213 is pasted by an adhesive agent or the like to the surface of the electrode layer 212 which is disposed in a predetermined position of the surface of the circuit board 211. Furthermore, the protection cover 214 is pasted onto the sensor portion.

In this case, since the electrodes 212a and 212b of the electrode layer 212 are formed together with a conductive pattern for configuring another circuit, on the surface of the circuit board 211 by printing carbon, the electrodes can be formed at a lower cost. Therefore, the number of parts is reduced, and a conductive pattern made of a metal is not required, with the result that the part cost and the assembly cost can be reduced.

When a connection pattern for connecting the electrodes 212a and 212b to other conductive patterns is simultaneously formed, it is not required to electrically connect the electrodes 212a and 212b to the other conductive pattern on the circuit board 211 by reflow soldering or the like. Consequently, the assembly workability and the production efficiency are improved, and occurrence of a disconnection failure is eliminated, whereby the reliability of a product is improved.

The pressure sensor 210 of the embodiment described above is to be incorporated into a circuit board of a controller for a game machine. It is obvious that the invention is not restricted to this, and can be applied also to various apparatuses comprising a pressure sensor having such a configuration, for example, a keyboard. In the embodiment, the pressure sensor 210 is covered by the protection cover 214. The invention is not restricted to this. The protection cover 214 may be omitted.

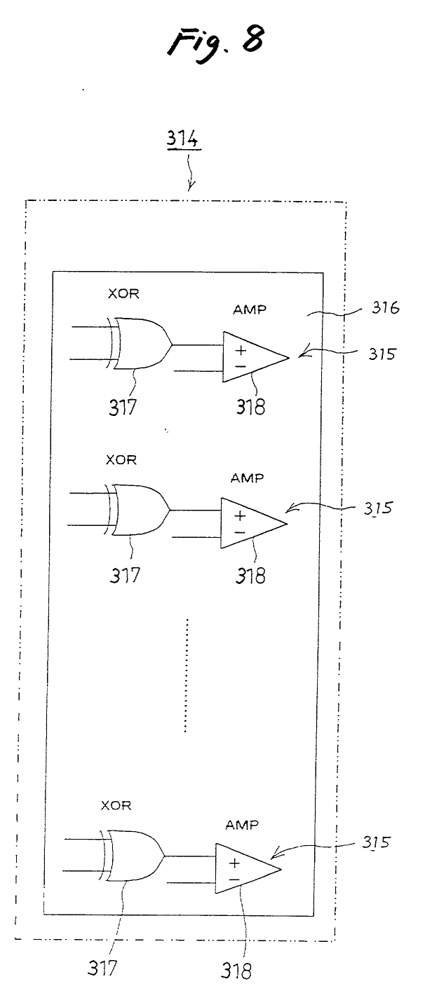

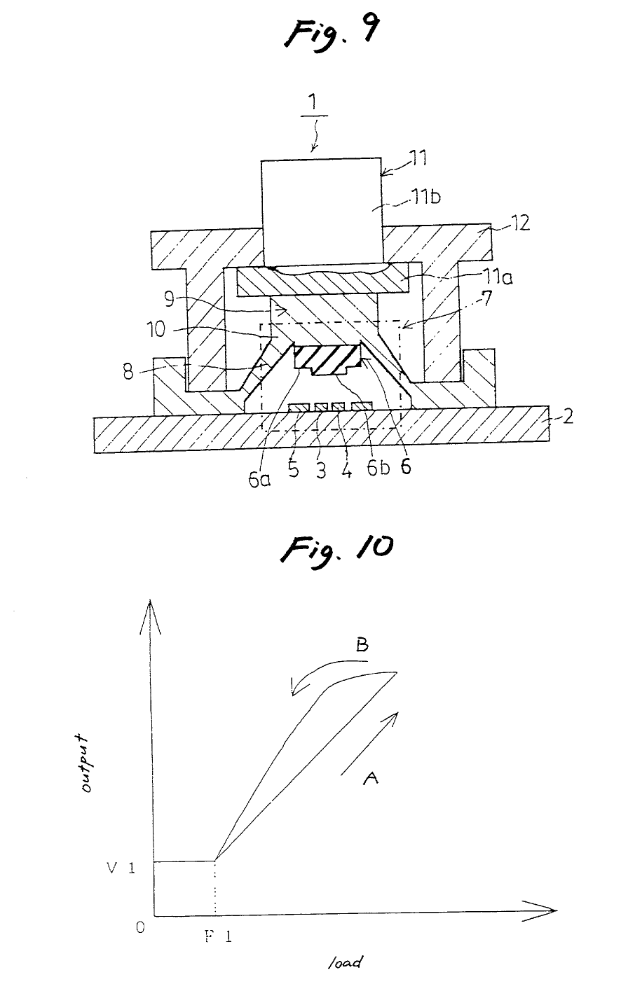

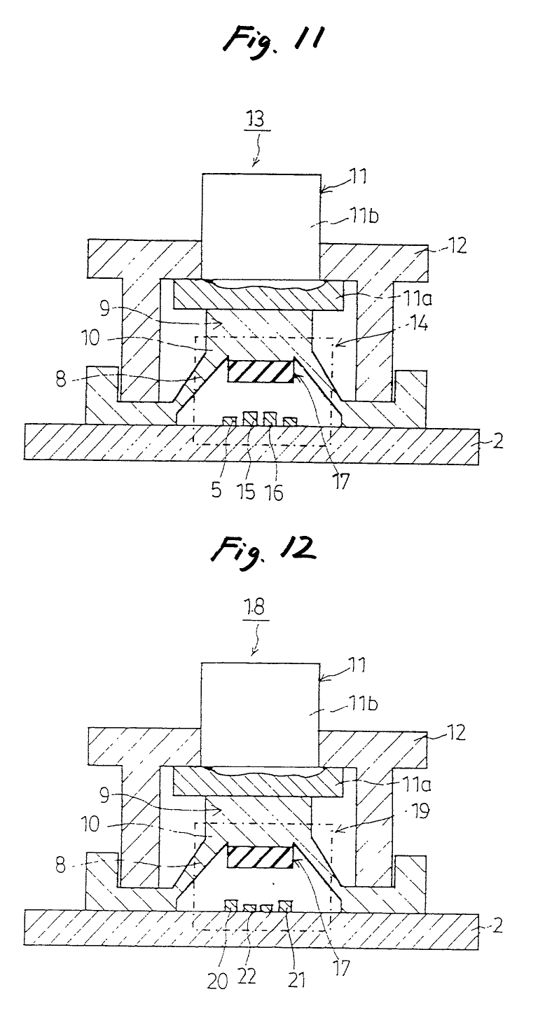

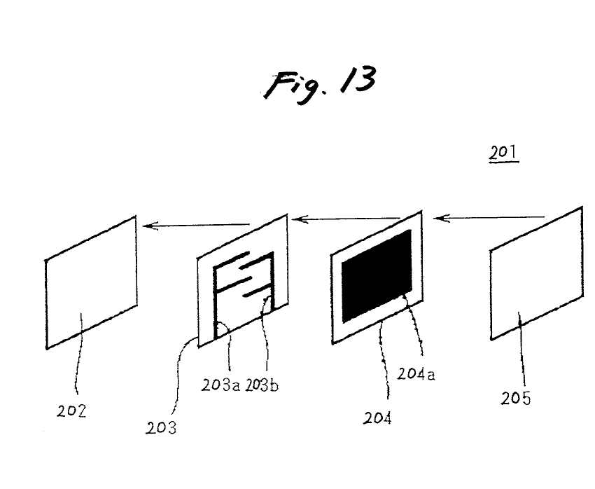

Next, the configuration to achieve the third object of the invention will be described with reference to FIG. 8 which is a schematic diagram showing a pressure circuit according to one embodiment of the invention.

For example, a pressure sensor circuit 314 is used in a contact portion of a switch or the like, and comprises a plurality of XOR-AMP circuits 315 which are adequately connected in the required number corresponding to the number of pressure sensors (not shown) that are used as contacts. The XOR-AMP circuits 315 are formed as an IC of one package in a single wafer 316.

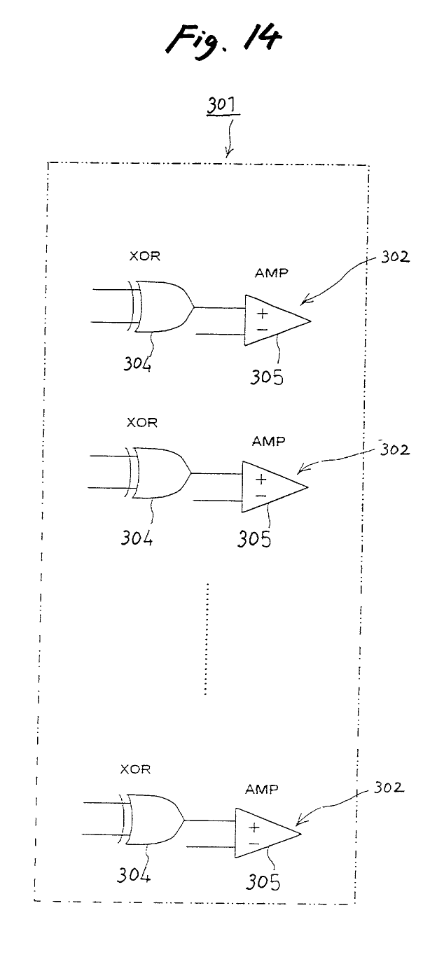

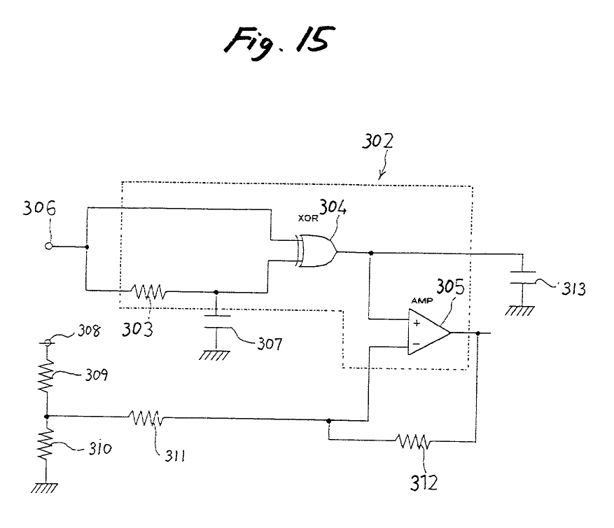

In each of the XOR-AMP circuits 315, for example, an XOR gate 317 which performs an exclusive OR operation, an AMP 318 serving as a differential amplifier which amplifies the difference between two signals, and a resistor (not shown) are disposed. The XOR-AMP circuit 315 is configured by the same circuit as the XOR-AMP circuit 302 of the related sensor circuit shown in FIG. 15. Similarly, the pressure sensor circuit 314 is configured by the same circuit as the related pressure sensor circuit 301 shown in FIG. 14. Therefore, detailed description of the XOR-AMP circuit 315 and the pressure sensor circuit 314 is omitted. However, the configurations of the XOR-AMP circuit 315 and the pressure sensor circuit 314 are not restricted to the above-described ones.

As described above, the XOR-AMP circuits 315 are formed as an IC of one package in the single wafer 316, and hence the XOR-AMP circuits 315 are produced by the same process. Therefore, dispersion of characteristics of the XOR-AMP circuits 315 is reduced. Consequently, also the characteristic of the pressure sensor circuit 314 configured by the XOR-AMP circuits 315 is stabilized, and an apparatus in which the pressure sensor circuit 314 is used is excellent in characteristic, quality, sense of use, etc. Furthermore, since the pressure sensor circuit 314 is formed in the single wafer 316, the number of parts can be reduced, and the XOR-AMP circuits 315 can be produced more economically than the general-purpose XOR-AMP circuits as explained with the related pressure sensor circuit, whereby the production cost can be lowered.

The plural XOR-AMP circuits which are to be formed in an IC of one package in the single wafer 316 are not restricted to the XOR-AMP circuits 315. Alternatively, other plural same circuits, or plural same parts may be formed in an IC of one package. In the alternative also, it is possible to attain the same effects such as that dispersion of characteristics of the same circuits, or the same parts is reduced, in the same manner as the above-described embodiment.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A pressure sensor, comprising:
a base board;
a first contact electrode formed on the base board;
a second contact electrode formed on the base board such that a top face thereof is made flush with a top face of the first contact electrode; and
a deformable click rubber having a flat bottom face opposed to the first and second contact electrodes the flat bottom face being parallel with the top faces of the first and second contact electrodes,
wherein the sensor generates an output signal when the bottom face of the click rubber is brought into contact with the first contact electrode; and
wherein a contact area between a bottom portion of the click rubber and the second contact electrode varies in accordance with the deformation of the click rubber to vary an amplitude of the output signal.

2. The pressure sensor as set forth in claim 1, wherein the click rubber has a columnar body whose bottom face is the flat face; and
wherein a hollowed portion is formed in an upper central portion of the columnar body such that a peripheral portion of the click rubber surrounding the hollowed is easier to deform than the bottom portion of the click rubber.

3. The pressure sensor as set forth in claim 1, wherein the first and second contact electrodes are carbon-printed on the base board.

4. A pressure sensor, comprising:
a base board;
a contact electrode formed on the base board; and
a deformable click rubber including a columnar body whose bottom face is opposed to the contact electrode,
wherein the sensor generates an output signal when the bottom face of the click rubber is brought into contact with the contact electrode;
wherein a contact area between a bottom portion of the click rubber and the contact electrode varies in accordance with the deformation of the click rubber to vary an amplitude of the output signal; and
wherein a hollowed portion is formed in an upper central portion of the columnar body such that a peripheral portion of the click rubber surrounding the hollowed is easier to deform than the bottom portion of the click rubber.

5. The pressure sensor as set forth in claim 4, wherein the contact electrode includes a first contact electrode and a second contact electrode whose top faces are made flush with each other; and
wherein the bottom face of the columnar body is made flat in parallel with the top faces of the first and second contact electrodes.

6. The pressure sensor as set forth in claim 4, wherein the contact electrode is carbon-printed on the base board.

7. A pressure sensor comprising:
an electrode layer including a contact electrode, the electrode layer integrally formed with a base board as a single layer; and
a sensor layer laminated on the electrode layer.

8. The pressure sensor as set forth in claim 7, wherein the contact electrode is carbon-printed on the base board.

9. A method of manufacturing a pressure sensor, comprising the steps of:
carbon-printing a contact electrode directly on a base board to form a single electrode layer; and
laminating a sensor layer on the electrode layer.

10. A pressure sensor circuit, comprising:
a plurality of circuits, each including an exclusive-OR gate element and an amplifier element which are connected in serial; and
a single wafer, on which the plural circuits are mounted.

11. A package integrated circuit, comprising:
a plurality of pressure sensor circuits, each including an exclusive-OR gate element and an amplifier element which are connected in serial; and
a single wafer, on which the plural pressure sensor circuits are mounted.
